(19) United States
(12) Patent Application Publication
(10) Pub. No.: US 2009/0089636 A1
(43) Pub. Date: Apr. 2, 2009

(54) Method and Apparatus for Logic Built In Self Test (LBIST) Fault Detection in Multi-Core Processors

(76) Inventors: Matthew E. Fernsler, Cedar Park, TX (US); Mack W. Riley, Austin, TX (US); Michael F. Wang, Chippewa Falls, WI (US)

Correspondence Address: DILLON & YUDELL LLP, 8911 N. CAPITAL OF TEXAS HWY.,, SUITE 2110, AUSTIN, TX, 78759, US

(21) Appl. No.: 11/865,153

(22) Filed: Oct. 1, 2007

(51) Int. Cl. G06F 11/263; G06F 11/25

(52) U.S. Cl. 714/728; 714/733; 714/E11.155; 714/E11.177

(57) ABSTRACT

A method, system, and computer program product for identifying failures in multi-core processors, utilizing logic built-in self test (LBIST) technology. Multi-core processors, having LBIST and pseudo-random pattern generator (PRPG) circuitry, are tested. Controlled by the LBIST control logic, PRPG inputs a test pattern into scan chains within the cores of each device. A new test pattern is generated and executed during the scan shift phase of each LBIST loop. Logic output generated by each scan chain in the core is compared to other core logic output. Failures within the multi-core processors are determined by whether the logic output generated from a core, within a latch sequence, does not match the logic output of the other cores. If logic output, from a core within a latch sequence, does not match, then the latch number, loop number, and latch values are recorded as failed.

### BACKGROUND

1. Technical Field

The present invention generally relates to the integrated circuit devices, and in particular to an improved system for testing for faults in multiprocessor integrated devices.

2. Description of the Related Art

Logic built in self test (LBIST) architecture is utilized to test the integrated circuit logic of high-end servers and computers. LBIST technology may exist at the integrated circuit level, multiple chip module (MCM) level, and/or system level. One of the primary advantages of LBIST is that the operation of the test is self-contained (i.e. all of the circuitry required to execute the test is contained within the integrated circuit).

The basic technology of LBIST utilizes a pseudo-random pattern generator (PRPG) to generate inputs to the internal scan chain of a device under test. Pseudo random patterns are shifted in to the scan chain of the device under test to initialize the latches of the scan chain. Following a sequence of functional (and hold) cycles, the latch values are shifted out and captured by the multiple input signature register (MISR). The compressed response that results from the MISR is called the signature. Any corruption in the output signature indicates a defect in the device. This process is repeated for thousands of loops to improve test coverage, with each loop having a unique input pattern.

Upon completion of the LBIST process, the MISR value (or signature) is analyzed. If the MISR signature does not match the expected signature, one or more faults are assumed in the logic. Locating the faults in the logic requires extensive work. The MISR registers the LBIST signature; however, there is no information of which latch within the device core failed, or the loop number of the failed latch. To identify failed latch positions, LBIST must first be executed on a working device, or chip. After each loop, all latch values are scanned and stored in a file. The identical LBIST pattern is executed again on devices with faults. Again, after each loop the latch values are scanned and stored in a file. Failing latches and loops are identified when values obtained from the working device and values obtained from the failed device are compared at the end of the entire sequence of loops.

Additionally, with current implementations of LBIST, diagnostics of failures are difficult since the pass/fail determination is made simply on the final MISR value, which provides no indication of when the fail occurred. Given the large number of loops in the LBIST, the resulting pass/fail determination following the entire testing period does not enable a designer or tester to identify the actual sequence which fails.

### SUMMARY OF ILLUSTRATIVE EMBODIMENTS

Disclosed are a method and system for identifying failures in logic devices, such as multi-core processors, utilizing enhanced logic built-in self test (LBIST) technology. Multiple identical processor cores are tested with LBIST and pseudo-random pattern generator (PRPG) circuitry associated with the multiple cores. Controlled by LBIST control logic, PRPG inputs an identical test pattern into scan chains within the processor. This test pattern is executed during the scan shift phase of each LBIST loop. Logic output generated by each scan chain output in a processor core is compared to corresponding scan chain outputs from other processor cores. Failures within the multi-core processors are determined by logic output generated within the latch sequence of the cores. When the logic output from a latch sequence within a core does not match logic output from the other identical cores, then the latch number, loop number, and latch values are recorded as failed.

In one embodiment, a method for executing LBIST on a multi-core processor is provided. Associated with each core of the multi-core processor is a PRPG that generates the test pattern input. A single LBIST controller is shared among the cores. Similarly, a single PRPG may be shared amongst the cores, which are identical, or alternatively, each core may have a separate PRPG embedded within the core. The PRPG drives the scan chain(s) during the scan shift phase of each LBIST loop, and then, during the scan shift phase the pattern generated by the PRPG is shifted into the scan chain(s). Following the execution of the LBIST loop, the resulting logic values are shifted out, and the generated output is shifted into compare logic within the LBIST control unit.

In another embodiment, a method for determining failure in the multi-core processor is provided. The logic output values are shifted out of the scan chains and into a compare logic, where the outputs of latches under test within the same sequence are compared. The logic checks whether all resulting values within the sequence are the same (i.e. all 1's or all 0's). If the resulting output values of the latches under test match, the latch passes; otherwise, the latch with a different output value fails.

In another embodiment, a method for documenting failed latches is provided. When values of sequential latches under test are not equal, there is at least one failed latch. The compare logic then signals the record logic to store the current loop number, latch number, and latch value(s) in an LBIST table. Information stored in the table is utilized to identify the position of logic failure within the multi-core device.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1A is a diagram of logic built-in self test (LBIST) architecture according to one embodiment of the invention;

FIG. 1B is a more detailed diagram of enhanced logic built-in self test (LBIST) architecture with single loop LBIST compare (SLLC) control logic, according to one embodiment of the invention;

FIG. 2 is a schematic diagram illustrating a system for determining failed latches within a multi-core processor under test in accordance with one embodiment of the invention;

FIG. 3A is an illustrative example of scan chain output according to one embodiment of the invention;

FIG. 3B is an illustrative example of latch failures identified by the LBIST control unit according to one embodiment of the invention; and

FIG. 4 is a flow diagram illustrating a method for determining failed latches of multi-core processor under test, in accordance with one embodiment of the invention.

### DETAILED DESCRIPTION OF AN ILLUSTRATIVE EMBODIMENT

The illustrative embodiments provide a method, system and computer program product for identifying failures in logic devices, such as multi-core processors, utilizing enhanced logic built-in self test (LBIST) technology. Multiple core processors designed with LBIST and pseudo-random pattern generator (PRPG) circuitry embedded in the cores of each device are utilized for testing. Controlled by the LBIST control logic, PRPG inputs a test pattern into scan chains within the cores of each device. A new test pattern is generated and executed during the scan shift phase of each LBIST loop. Logic output generated by each scan chain output in the processor core is compared to corresponding scan chain outputs from other processor cores. Failures within the multi-core processors are determined when logic outputs generated by the cores, within a latch sequence, do not match. When logic output from a core within a test pattern sequence does not match the logic output from the other cores, then the latch number, loop number, and latch values are recorded and stored.

While the invention is illustrated and described herein with specific reference to processor cores, the features of the invention are applicable to any type of logic device(s), which are designed with LBIST functionality therein. Specific reference to processors and processor cores herein are not intended to limit the invention to this type of logic device, which serves merely as an example of the illustrative embodiment.

Also, it should be noted that the features of the invention may be implemented along with the conventional LBIST MISR based implementations within a single device. Thus, according to such an implementation, the traditional method of completing LBIST is carried out by the conventional LBIST MISR; however, the enhanced LBIST method provided by the present invention is also implemented to provide in-time detection and reporting of LBIST failures at the latch level. The invention thus provides a mechanism to obtain LBIST failure information easier and quicker, while not necessarily preventing the traditional mechanism from completing general LBIST failure detection on the same device. As further described herein, the mechanisms provided by the invention greatly simplifies the design of automated mechanisms to diagnose LBIST failures.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

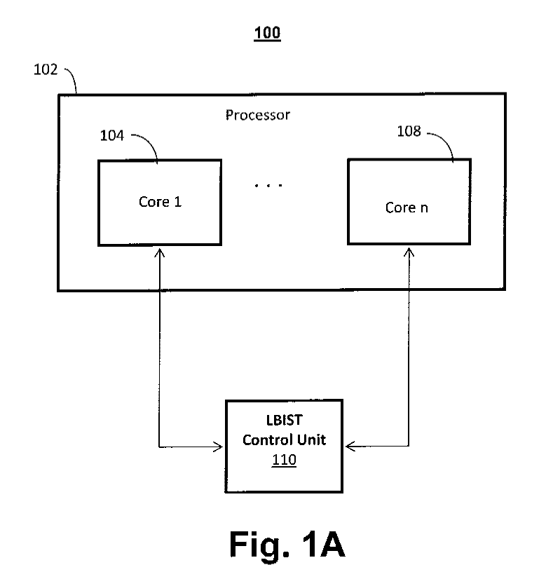

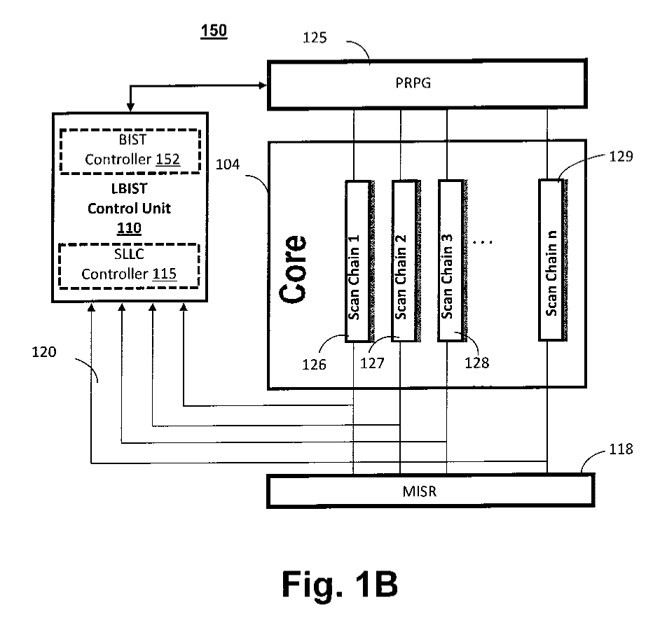

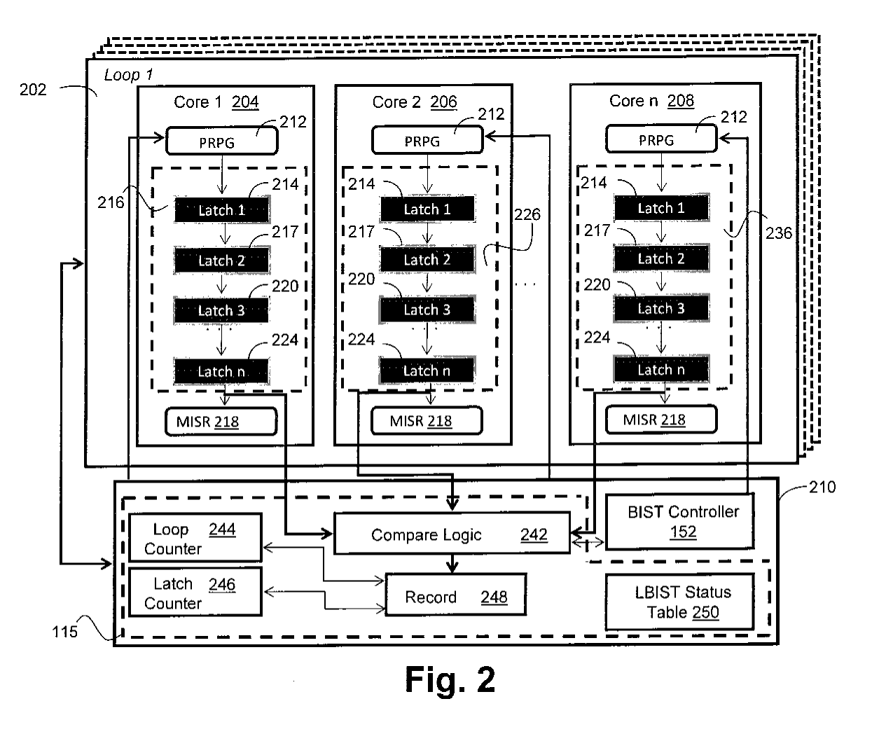

Within the descriptions of the figures, similar elements are provided similar names and reference numerals as those of the previous figure(s). Where a later figure utilizes the element in a different context or with different functionality, the element is provided a different leading numeral representative of the figure number (e.g, 1xx for FIG. 1 and 2xx for FIG. 2). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

With reference now to the figures, FIG. 1A shows a system for testing a multi-core microprocessor utilizing logic built-in self test (LBIST) technology. LBIST system 100 comprises processor 102 that contains multiple cores, core 1 104 and core n 108 (with ‘n’ representing an unspecified number of cores). Processor 102 communicates with LBIST control unit 110. The LBIST process is initiated by LBIST control unit 110, which as described herein, is an enhanced LBIST control unit having additional logic components for enabling the features of the invention. In processor 102 every core is identical from the perspective of LBIST system 100. Therefore, during each cycle of testing, a pseudo-random pattern is generated and the same pattern shifted into the internal scan chains of core 1 104 through core n 108. After the pseudo-random pattern has shifted through the internal scan chains of core 1 104 through core n 108, (enhanced) LBIST control unit 110 receives the logic output generated by the internal scan chains. Scan chains within core 1 104 through core n 108 are illustrated in FIG. 2.

FIG. 1B depicts a block diagram of an enhanced logic built-in self test (LBIST) architecture within which features of the invention may be advantageously implemented. LBIST architecture 150 comprises enhanced LBIST control unit 110 coupled to PRPG 125. Core 104 (representing example core 104 of FIG. 1A) comprises multiple parallel scan chains, scan chains 126, 127, 128, and 129. Multiple latches within the cores of a multi-core processor are chained together to form scan chains. PRPG 125 has a series of outputs coupled to scan chains 126, 127, 128, and 139 within core 104 of the device under test. Scan chains 126, 127, 128, and 129 have a single output from each scan chain that is fed into enhanced LBIST control unit 110 and MISR 118.

Enhanced LBIST control unit 110 comprises built-in self test (BIST) controller 152, which generates all waveforms for repeatedly loading pseudo-random patterns into scan chains 126, 127, 128, and 129 during each loop sequence of testing. BIST controller 152 initiates the LBIST loop sequence, or capture cycle, for outputting the resulting logic of scan chains 126, 127, 128, and 139 to LBIST control unit 110 and MISR 118.

Enhanced LBIST control unit 110 also comprises single loop LBIST compare (SLLC) controller/logic 115. SLLC controller 115 represents the enhancement to the conventional LBIST and provides the functional features of the invention as described herein. Logic components within SLLC controller 115 are illustrated and described in further detail in FIG. 2.

PRPG 125 generates test patterns that are passed through scan chains 126, 127, 128, and 129 so that the latches receive the bits of the generated pattern. The generated pattern propagates through the latches. Logic results of scan chains 126, 127, 128, and 139 are then scanned out of the scan chains to LBIST control unit 110 (and specifically to components of SLLC controller 115), where fault detection is initiated, as illustrated by FIG. 2, described below. In one embodiment, MISR 118 compresses the accumulated responses into a code known as a signature. The signature is utilized in conjunction with fault detection results of LBIST control unit 110 to optimize identification of failed latches.

In one embodiment, the scan out data is returned/forwarded to a central location, which may be independent of the location of the core. The comparison of scan out data is thus not dependent on the location of one core relative to the other cores. Additionally, while the architecture described in some embodiments indicate the PRPG is tied to the core, other embodiments may have a single PRPG, which is shared among the multiple cores. These latter embodiments are particularly applicable to architectures having “LBIST identical” cores, since the test process tries to guarantee that the identical cores see the same exact pattern each time a test sequence is run.

Those of ordinary skill in the art will appreciate that the hardware depicted in FIG. 1B is a basic illustration of LBIST architecture for a processor core, and thus the hardware utilized in actual implementation may vary. For example, other devices/components, such as scan clocks and system clocks, may be used in addition to the hardware depicted.

With reference now to FIG. 2 which illustrates a system for determining failed latches within a multi-core processor under test. In FIG. 2, loop 1 202 comprises core 1 204, core 2 206, and core n 208 (with ‘n’ representing an unspecified number of cores) of a multi-core processor. While there are multiple cores as shown in FIG. 2, only a single core is shown and described here for simplicity. Thus, the depicted example is not meant to imply architectural limitations with respect to the present invention. Within each core of FIG. 2, a single scan chain is depicted. There are often multiple scan chains within the core of a multi-core processor; however, a single scan chain is shown for simplicity. Scan chains 216, 226, and 236 are each composed of a series of latches, latch 1 214, latch 2 217, latch 3 220, and latch n 224 (with ‘n’ representing an unspecified number of latches). The input of scan chain 216, 226, and 236 is coupled to PRPG 212, and the output coupled to MISR 218.

As described above, output from each of the multiple scan chains are received by enhanced LBIST controller 210, which includes BIST controller 152 and components of SLLC controller 115. Among the components of SLLC controller 115 are compare logic 242, loop counter 244, latch counter 246, record 248, and LBIST status table 250. These components represent the enhancements to LBIST, which enables LBIST to provide the functionality described herein, including on-the-fly, latch-level identification of failures following each LBIST loop.

Compare logic 242, which resides in LBIST control unit 210, is also coupled to the output of scan chain 216, 226, and 236. LBIST control unit 210 encompasses BIST controller 152, as seen in FIG. 1. BIST controller 252 generates all waveforms for repeatedly loading pseudo-random patterns, and BIST controller 252 initiates the LBIST loop sequence, loop 1 202, of an unspecified number of sequences. LBIST control unit 210 also comprises compare logic 242, loop counter 244, latch counter 246, record 248, and LBIST status table 250.

During a loop sequence, loop 1 202, the latches of LBIST scan chain experience a number of cycles exposing the latches to unique pseudo-random patterns. A different pattern is created with each new loop sequence. In FIG. 2, the loop sequence of loop 1 202 proceeds as follows. First, a pseudo-random pattern is generated by PRPG 212 and shifted into scan chain 216, 226, and 236 in core 1 204, core 2 206, and core n 208, respectively. The pseudo-random pattern is scanned into scan chain 216, 226, and 236 so that latch 1 214, latch 2 217, latch 3 220, and latch n 224 are populated with the bits of the pseudo-random pattern. Next, the bits that are stored in latch 1 214, latch 2 217, latch 3 220, and latch n 224 are allowed to propagate through the functional logic components.

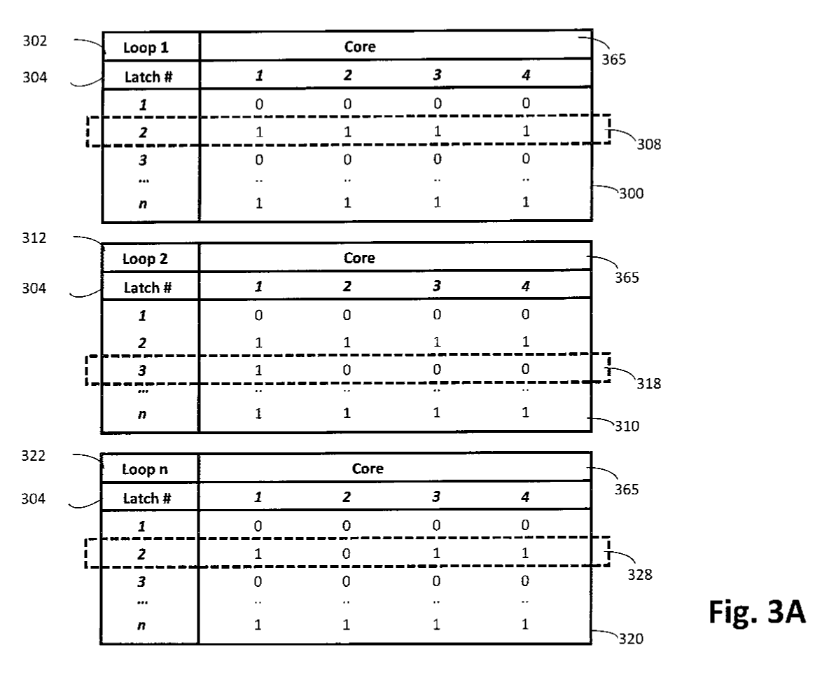

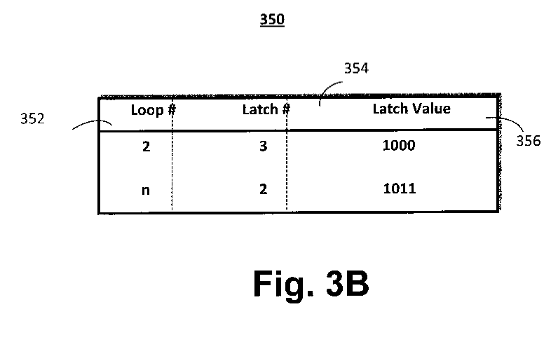

In one embodiment, the output from scan chains 216, 226, and 236 is transferred to compare logic 242, where the logic output of latch 1 214, latch 2 217, latch 3 220, and latch n 224 is compared to the output from other cores, which may or may not be adjacent. Logic output generated by each core is compared to the corresponding latch in the other cores. The latch output is a one (1) or zero (0). For example, given the logic output of latch 1 214 in core 1 204 matches the logic output from latch 1 214 of core 2 206 and core n 208 (and all cores in between), then that latch sequence including core 1 204, core 2 206, and core n 208 (and all cores in between) passes. An example “pass” output is illustrated by latch sequence 308 in FIG. 3A, which is described below.

In one embodiment, if the output of a latch in a core does not match then, compare logic 242 transfers the logic values to record 248. Record 248 also prompts loop counter 244 and latch counter 246 to input the current loop number and latch number into record 248. When record 248 has received the failed latch value from compare logic 242, loop number from loop counter 244, and latch number from latch counter 246, the data is stored in LBIST status table 250. Example “fail” output is illustrated by fail latch sequence 318 in FIG. 3A, which is described below

FIG. 3A illustrates output received from a four core processor. Following each loop sequence, the latch values are shifted out serially to compare logic 242. Output tables 300, 310, and 320 display example input to compare logic 242. Latch values are represented for one through n loop sequences (where ‘n’ is an unspecified number of loop sequences), loop 1 302, loop 2 312, and loop n 322. Cores 365 depict cores one through four of output table 300, 310, and 320. Each loop is a newly generated pattern shifted in to the scan chains. Latch number (#) 304, of loop 1 output table 300, loop 2 output table 310, and loop n output table 320 represents the respective latch number for the scan chain under test. The logic output of each latch is compared to the logic output of the corresponding latch in the other cores (i.e. the latch sequence). A latch sequence is clearly displayed in loop 1 output table 300 as latch sequence 308.

In one embodiment, loop 1 output table 300 illustrates passing latch values for cores one through four of cores 365, for each latch sequence. Latch sequence 308 displays all ‘1's’ representing a “pass” latch sequence. A passing latch sequence is equivalent to latch output of all ones or all zeros for core one through four of cores 365 within a latch sequence.

Failed latch sequences are identified as latch sequences with logic values that are not all ones or all zeros. In the illustrative embodiment of FIG. 3A failed latch sequences are represented by loop 2 fail latch sequence 318 and loop 3 fail latch sequence 328. In loop 2 fail latch sequence 318, latch three of core one causes the latch sequence to fail. In loop 3 fail latch sequence 328, latch two of core two causes the latch sequence to fail. Each failed latch sequences is recorded and maintained in LBIST status table 350 of FIG. 3B.

In the illustrative embodiment of FIG. 3B, LBIST status table 350 is displayed. LBIST status table 350 reports the failed latch sequences of FIG. 3A. LBIST status table 350 comprises loop number 352, latch number 354, and latch value 356. Failed latches are identified utilizing the information displayed in LBIST status table 350. LBIST status table 350 displays a failed latch at loop 2, latch 3, and core 1. Another failed latch is recorded at loop n, latch 2, and core 2.

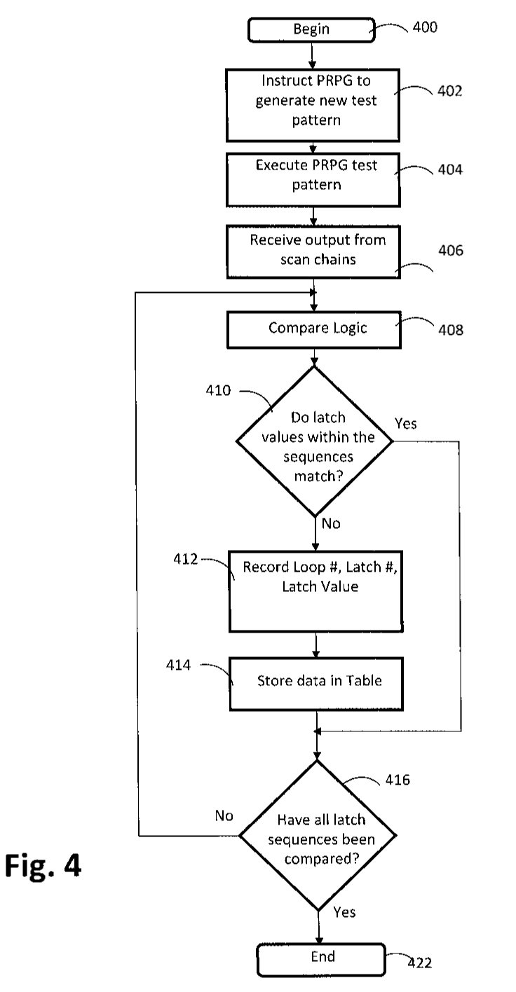

FIG. 4 is a flow chart illustrating a method by which the above processes of the illustrative embodiments are completed. Although the methods illustrated in FIG. 4 may be described with reference to components shown in FIGS. 1-3, it should be understood that this is merely for convenience and alternative components and/or configurations thereof can be employed when implementing the various methods. The process of FIG. 4 begins at initiator block 400 and proceeds to block 402, at which instructions are received by the PRPG to generate a pseudo-random test pattern. The pseudo-random test pattern is generated and executed at step 404 by shifting the pattern into scan chains, as illustrated in FIG. 2. After the pattern has shifted through the scan chain, the data in the scan chain is shifted out at step 406.

Latches within the multi-core processor under test are identified as pass or fail following a comparison of the scan chain logic output. At step 408, outputs from the scan chains are compared by compare logic 242 of FIG. 2. Output from latch values within each latch sequence is analyzed. A determination is made at step 410 whether the latch values within the latch sequence match. If the latch values match, the process proceeds to block 416 where another determination is made whether to compare another latch sequence. If the latch values do not match, the loop number, latch number, and latch values are recorded, at step 412. After recording the failed latch sequence information, the data is stored in an LBIST status table, such as that of FIG. 3B, as provided at step 414.

Within a single loop of LBIST, the same pseudo-random pattern is shifted into each latch sequence of the scan chains, until each latch in the scan chain has been exposed to the pseudo-random pattern. Following each latch sequence, a determination is made at step 416 whether to compare the next latch sequence, or end that LBIST loop sequence. If a decision is received to compare the next latch sequence, the process returns to block 408 and repeats the compare process until each latch sequence has been compared. If there are no more latch sequences remaining, the LBIST loop ends at step 422. This process is repeated for thousands of loops to improve test coverage.

Implementation of the enhanced LBIST controller described herein enables several functional features that are not currently provided with a conventional LBIST controller. The enhanced LBIST controller enables the following beneficial outcomes, among others, from executing an LBIST sequence:

(1) Rather than simply providing a signature, which has to then be compared at the tester to determine pass/fail status, as with conventional LBIST implementation, the enhanced LBIST provides the ability to identify the exact failing latch;

(2) With conventional LBIST implementation, MISR signatures require a stored value to be placed in the test pattern to compare for pass/fail status. The enhanced LBST does not require a stored signature as with conventional LBIST. The enhanced LBIST provides real-time pass/fail information for the tester by comparing the results of the different cores against each other. The redundancy of identical (or substantially identical) logic, having similar scan chains and latch configurations, enables each scan chain output to serve as a comparative value for the other scan chain outputs, where a failure is automatically indicated if any one of the outputs from a loop is different from the others;

(23) Because each latch output is compared at the time of the loop to the output of the other latches, the enhanced LBIST provides the ability to identify failing latches in real time, with only one pass of the LBIST sequence required;

(4) Also, the enhanced LBIST provides the ability to identify failing loop count in real time, unlike conventional LBIST implementations, which require a later debug effort to determine the LBIST loop that failed;

(5) As described above with the various illustrative embodiments, the enhanced LBIST also generates/provides information to enable easy debug of failures. For example, enhanced LBIST tracks/records the loop count and latch number for each failure, which makes for a straight forward to step through of the LBIST sequence to observe the events that occurred and which caused the failure; and

(6) The enhanced LBIST provides a mechanism to enable easier implementation of automated LBIST failure diagnostics via automated testers or lab debug tools, which are provide access to the generated tables of data.

In the flow charts above, one or more of the methods are embodied in microcode such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A system for identifying failures in a logic device utilizing logic built-in self test (LBIST) technology, said system comprising:
a logic device containing a plurality of identical components, with each identical component having at least one scan chain within the component;
at least one pseudo-random pattern generator (PRPG) which generates pseudo-random test patterns for shifting into the at least one scan chain of the identical component;
logic for triggering execution of LBIST on the scan chains within the plurality of identical component utilizing the PRPG to generate a test pattern that is shifted though the at least one scan chain of two or more of the plurality of identical component to yield a plurality of logic outputs, each associated with one of the scan chains; and
logic for evaluating when at least one of the scan chains fails the LBIST based on a comparison of the plurality of logic outputs.

2. The system of claim 1, wherein said logic device further comprises:
an LBIST control unit;
logic for communicating with the LBIST control unit to initialize latches on the at least one scan chain, wherein said at least one scan chain is comprised of one or more latches; and
logic for initiating generation of a pseudo-random test pattern via the PRPG, wherein said PRPG includes logic for shifting the test pattern into the latches of the at least one scan chain of the two or more identical components;
wherein the scan chains comprise means for propagating the generated test pattern through the one or more latches of the scan chains.

3. The system of claim 1, further comprising:
a comparator logic for receiving the plurality of logic outputs of the scan chains of the two or more identical components after the pseudo-random test pattern has been shifted through each latch of the scan chains; and
wherein said logic for evaluating includes said comparator logic and comprises:
logic for comparing each of the logic outputs against other logic outputs of a same loop sequence to determine whether one or more of the logic outputs does not match the other logic outputs of that loop sequence; and
logic for storing a result of the comparing logic within a pre-established storage location when the result indicates a detection of a failure.

4. The system of claim 3, further comprising:
a storage mechanism; and
logic for receiving and storing parameters of a scan latch sequence that failed the LBIST, said parameters including one or more of a test cycle identifier, a loop number, and a latch number, wherein said logic enables real time identification of a failed latch and a failed loop.

5. The system of claim 2, wherein said LBIST control unit further comprises:
logic for initiating a test cycle in which a comparison is completed against each latch sequence passed through the one or more scan chains of the two or more identical components to identify failures; and
logic for completing said test cycle when all latch sequences have been compared.

6. The system of claim 5, further comprising:
logic for comparing scan chain logic output from the two or more identical components of the logic device at the end of each test cycle;
logic for generating a new output for latch sequence within the test cycle, wherein if the logic output for a single latch sequence is not the same for all components within the latch sequence, then the latch sequence is tagged as a failed latch sequence, independent of the other latch sequences within the test cycle; and
logic for recording each failed latch sequence, uniquely identified by a latch sequence identifier.

7. The system of claim 1, wherein said logic for evaluating comprises:
logic for identifying, in real time, a failing latch within the at least one scan chain by comparing each scan output corresponding to a sequence of similar latches across the two or more components for a latch whose value does not match with values of other latches within the sequence of similar latches;
wherein said logic for identifying the failing latch comprises logic for comparing values across the sequence of similar latches without requiring external values for completing a comparison; and
wherein said logic for identifying the failing latch performs the comparison after each pass of an LBIST sequence such that the failing latch is identified with a single pass of the LBIST sequence.

8. The system of claim 1, wherein said logic for evaluating comprises:
logic for identifying a failing loop count in real time, without requiring a later debug of collected data to determine the LBIST loop that failed;
logic for storing a loop count along with other identifying information when a failed latch is detected within a scan output.

9. The system of claim 1, further comprising:
logic for recording identifying information related to a detected failure, said information including one or more of a loop count and a latch number associated with the detected failure, wherein said recording is completed in real time as the failure is detected; and
logic for enabling access to a failure record generated by storing the identifying information about each detected failure, said logic providing an automated LBIST failure diagnostics via an automated tester or a lab debug tool provided access to the recorded identifying information.

10. A multi-core processor comprising:
a plurality of identical cores, with each identical core having at least one scan chain within the core;
at least one pseudo-random pattern generator (PRPG) which generates pseudo-random test patterns for shifting into the at least one scan chain of the identical cores;
logic for triggering execution of logic built-in self test LBIST on the scan chains within the plurality of identical cores utilizing the PRPG to generate a test pattern that is shifted though the at least one scan chain of two or more of the plurality of identical cores to yield a plurality of logic outputs, each associated with one of the scan chains; and
logic for evaluating when at least one of the scan chains fails the LBIST based on a comparison of the plurality of logic outputs.

11. The processor of claim 10, further comprising:
an LBIST control unit;
logic for communicating with the LBIST control unit to initialize latches on the at least one scan chain, wherein said at least one scan chain is composed of one or more latches; and
logic for initiating generation of a pseudo-random test pattern via the PRPG, wherein said PRPG includes logic for shifting the test pattern into the latches of the at least one scan chain of the two or more identical cores;
wherein the scan chains comprise means for propagating the generated test pattern through the one or more latches of the scan chains.

12. The processor of claim 10, further comprising:
a comparator logic for receiving the plurality of logic outputs of the scan chains of the two or more identical cores after the pseudo-random test pattern has been shifted through each latch of the scan chains; and
wherein said logic for evaluating includes said comparator logic and comprises:
logic for comparing each of the logic outputs against other logic outputs of a same loop sequence to determine whether one or more of the logic outputs does not match the other logic outputs from that loop sequence; and
logic for storing a result of the comparing logic within a storage location.

13. The processor of claim 12, further comprising:
a storage mechanism; and
logic for receiving and storing parameters of a scan latch sequence that failed the LBIST, said parameters including one or more of a test cycle identifier, a loop number, and a latch number, wherein said logic enables real time identification of a failed latch and a failed loop.

14. The processor of claim 11, wherein said LBIST control unit further comprises:
logic for initiating a test cycle in which a comparison is completed for each latch sequence passed through the one or more scan chains of the two or more identical cores to identify failures; and
logic for completing said test cycle when all latch sequences have been compared.

15. The processor of claim 14, further comprising:
logic for comparing scan chain logic output from the two or more identical cores of the multi-core processor at the end of each test cycle;
logic for generating a new output for each latch sequence within the test cycle, wherein if the logic output for a single latch sequence is not the same for all cores within the latch sequence, then the latch sequence is tagged as a failed latch sequence, independent of the other latch sequences within the test cycle; and
logic for recording each failed latch sequence, uniquely identified by a latch sequence identifier.

16. The processor of claim 10, wherein said logic for evaluating comprises:
logic for identifying, in real time, a failing latch within the at least one scan chain by comparing each scan output corresponding to a sequence of similar latches across the two or more cores for a latch whose value does not match with values of other latches within the sequence of similar latches;
wherein said logic for identifying the failing latch comprises logic for comparing values across the sequence of similar latches without requiring external values for completing a comparison; and
wherein said logic for identifying the failing latch performs the comparison after each pass of an LBIST sequence such that the failing latch is identified with a single pass of the LBIST sequence.

17. The processor of claim 10, wherein said logic for evaluating comprises:
logic for identifying a failing loop count in real time, without requiring a later debug of collected data to determine the LBIST loop that failed;
logic for storing a loop count along with other identifying information when a failed latch is detected within a scan output.

18. The processor of claim 10, further comprising:
logic for recording identifying information related to a detected failure, said information including one or more of a loop count and a latch number associated with the detected failure, wherein said recording is completed in real time as the failure is detected; and
logic for enabling access to a failure record generated by storing the identifying information about each detected failure, said logic providing an automated LBIST failure diagnostics via an automated tester or a lab debug tool provided access to the recorded identifying information.

19. A method for identifying failures in multi-core processors utilizing logic built-in self test (LBIST) technology, with two or more identical cores each having at least one scan chain, said method comprising:
generating a pseudo-random test pattern for shifting into the at least one scan chain of the two or more identical cores;
comparing logic outputs generated from each of the at least one scan chain of the two or more identical cores to determine whether the logic outputs match; and
when one of the logic outputs does not match, recording identifying parameters of the scan chain whose logic output does not match to indicate that the scan chain failed.

20. The method of claim 19, wherein said at least one scan chain of the two or more cores contain one or more latches, said method further comprises:
triggering an LBIST control unit to initialize the one or more latches within the two or more cores;
wherein generating a pseudo-random test pattern is completed by initiating a PRPG that generates a test pattern and shifts the test pattern into the one or more latches of the scan chains of the two or more identical cores such that the test pattern propagates through the latches; and
receiving the logic output of the scan chains after the pseudo-random test pattern has been shifted through each latch of the scan chains.

21. The method of claim 20, wherein said evaluating further comprises:
forwarding the logic outputs to a comparator logic, which compares the logic output from each scan chain to the logic output of other scan chains;
providing comparisons for each latch sequence within the multi-core processor, wherein said LBIST test cycle is not complete until all latch sequences have been compared;
identifying, in real time, a failing latch within the scan chains by comparing each logic output corresponding to a sequence of similar latches across the two or more cores for a latch whose value does not match with values of other latches within the sequence of similar latches;
wherein said identifying the failing latch comprises: (a) comparing values across the sequence of similar latches without requiring external values for completing a comparison; and (b) performing the comparison after each pass of an LBIST sequence such that the failing latch is identified with a single pass of the LBIST sequence.
identifying a failing loop count in real time, without requiring a later debug of collected data to determine the LBIST loop that failed;
storing a loop count along with other identifying information when a failed latch is detected within a scan loop.

22. The method of claim 19, further comprising:
initiating a test cycle in which a comparison is completed for each latch sequence passed through the one or more scan chains of the two or more identical cores;
completing said test cycle when all latch sequences have been compared;
recording identifying information related to a detected failure, said information including one or more of a loop count and a latch number associated with the detected failure, wherein said recording is completed in real time as the failure is detected; and
enabling access to a failure record generated by storing the identifying information about each detected failure, said logic providing an automated LBIST failure diagnostics via an automated tester or a lab debug tool provided access to the recorded identifying information.

23. The method of claim 19, further comprising:
comparing scan chain logic output from the two or more identical cores of the multi-core processor at the end of a test cycle;
generating a new output for each latch sequence within the test cycle, wherein if the logic output for a single latch sequence is not the same for all cores within the latch sequence, then the latch sequence is tagged as a failed latch sequence, independent of the other latch sequences within the test cycle; and
recording each failed latch sequence, uniquely identified by a latch sequence identifier.

24. A computer program product comprising:
a computer readable medium; and
system-level code stored on the computer readable medium and which initializes a LBIST control unit to perform the functions of claim 19 within a multi-core processor with an PRPG and identical cores having at least one scan chain.

25. The computer program product of claim 24, said system level code further comprising code for performing the functions of:
triggering an LBIST control unit to initialize the one or more latches within the two or more cores;
wherein generating a pseudo-random test pattern is completed by initiating a PRPG that generates a test pattern and shifts the test pattern into the one or more latches of the scan chains of the two or more identical cores such that the test pattern propagates through the latches; and
receiving the logic output of the scan chains after the pseudo-random test pattern has been shifted through each latch of the scan chains.

26. The computer program product, said system level code further comprising code for performing the functions of claim 17.
